(19) United States
(12) Patent Application Publication
(10) Pub. No.: US 2008/0048077 A1
(43) Pub. Date: Feb. 28, 2008

(54) Device for Attaching a Decorative Element to a Vehicle

(76) Inventors: Michael Dupuis, Hartford, CT (US); Christopher Jon Wicken, Denver, CO (US)

Correspondence Address: MCCORMICK, PAULDING & HUBER LLP, CITY PLACE II, 185 ASYLUM STREET, HARTFORD, CT, 06103, US

(21) Appl. No.: 11/929,151

(22) Filed: Oct. 30, 2007

Related U.S. Application Data
(63) Continuation-in-part of application No. 11/174,748, filed on Jul. 5, 2005.
(60) Provisional application No. 60/587,700, filed on Jul. 14, 2004.

(51) Int. Cl. F16B 47/00

(52) U.S. Cl. 248/205.5; 248/205.1

(57) ABSTRACT

A device for attaching a decorative element to a vehicle including a support member attachable to a load surface of the vehicle, the support member having a shaft support, a shaft having first and second opposing ends, the first end of the shaft being attached to the shaft support, the shaft support being arranged for supporting the shaft in a generally upright position relative to an angularly disposed load surface. A display device mount is attached to the second end of the shaft, the display device mount including a flange defining a bore receiving the second end of the shaft, and a cup defining a conical sidewall extending outwardly from the flange, opposite the bore. A web extends between an outer surface of the conical sidewall and the flange for supporting the cup, the web defining a hook for attaching a display device to the mount.

### CROSS REFERENCE TO RELATED APPLICATIONS

This application is a continuation-in-part of pending U.S. patent application Ser. No. 11/174,748, filed Jul. 5, 2005 entitled “Device for Attaching Balloon to Automobile”. Applicant claims priority of the above-identified parent application which is incorporated herein by reference in its entirety. Priority is also hereby claimed to U.S. Provisional Application Ser. No. 60/587,700 filed on Jul. 14, 2004 which is incorporated herein by reference in its entirety.

### BACKGROUND OF THE INVENTION

The present invention is a device for attaching a decorative element to an automobile. Devices for attaching decorative elements to automobiles have been known for some time. The present invention is intended to solve problems associated with prior devices and means of attaching decorative elements to automobiles.

In particular, the present device allows attachment of a decorative balloon to an automobile in a manner that resembles the free-flowing form of a latex balloon attached to the automobile by flexible means such as a string or ribbon, while having improved wind resistance and durability; providing secure attachment in a manner that does not damage the automobile; allowing easy attachment, detachment, balloon replacement, and maintenance with minimal time and labor; and improving cost-effectiveness by eliminating the need for helium to keep the balloon aloft. The device is particularly useful in automobile sales lot applications, where balloons or other inflatable devices are attached to stationary automobiles to attract the attention of passersby; in this environment, conventional attachment methods and devices lack durability and are costly and labor-intensive to attach, maintain, and detach.

### SUMMARY OF THE INVENTION

The present invention is a device for secure attachment of a decorative element to an automobile. The decorative element can include an air-filled balloon attached to an automobile using the device for providing an appearance resembling the free-flowing form of a helium-filled latex balloon attached to the automobile via a string, ribbon, or other similar flexible means, with the benefits described in the preceding paragraph. The device itself is attached by any conventional means to an automobile, but in one preferred embodiment is attached to the automobile by means of a bracket or wedge that is inserted between the outer surface of a side window of the automobile and the portion of the automobile body abutting the lower exposed end of the outer surface of the side window, allowing attachment of the device to an automobile without need to roll the window up or down. The bracket is attached to an upright shaft member, the first, lower portion of which is relatively rigid and disposed upwardly from the automobile so as to hold the upright shaft sufficiently far away from the automobile to minimize damage to the automobile. The first lower portion of the shaft is attached to a second upper portion of the shaft, the second portion extending upwardly therefrom and being more flexible than the first portion. In other embodiments, the shaft can be formed of one Attached by any conventional means to the uppermost part of the second portion is a means for attaching a balloon. This means for attaching a balloon can be in the form of a balloon cup adapted for secure yet replaceable attachment of a balloon to the end of the second member. It is an object of the invention to have the second, more flexible upper portion of the shaft be sufficiently flexible to allow a balloon attached at its upper end to move in a manner resembling the free-flying motion of a balloon attached via a highly flexible string. When air is moving, the motions of a balloon flying, swaying and dipping in the wind are resembled, and yet the shaft does not damage the automobile due to the relatively rigid nature of the first portion thereof.

In one embodiment, the present invention provides a device for attaching a decorative element to an automobile including a suction cup mount having a body and a seal coupled to the body. The seal defining a mounting surface which is removably attachable to a load surface of the automobile such as the windshield or a body panel of the vehicle. The body defining a shaft support for supporting an end of a shaft. The shaft having first and second opposing ends, the first end of the shaft removably attached to the shaft support of the body, the second end of the shaft configured for attaching a decorative element thereto.

### BRIEF DESCRIPTION OF THE DRAWINGS

Novel features of the device in accordance with the present invention will be more readily understood from a consideration of the following description taken together with the accompanying drawings, in which embodiments of the device include the various parts thereof identified by the same reference characters in each of the views.

FIG. 1 is a side elevational view of one embodiment of a device for attaching a balloon to an automobile in accordance with the present invention, showing partial cross sections thereof.

FIG. 2 is a front elevational view of the device of FIG. 1, shown without the balloon cup portion of the device.

FIG. 3 is a perspective view of an embodiment of a portion of the device, showing a wedge for attaching the device to an automobile connected to the shaft member of the device.

FIG. 4 is a perspective view of an embodiment of the more flexible second upper portion of the shaft of an embodiment of the device, with a balloon cup at its uppermost end.

FIG. 5 is a perspective view of the balloon cup portion of the device attached to the upper portion of the shaft, the balloon cup shown with a balloon attached thereto.

FIG. 6A is an exploded perspective view of a portion of an embodiment of the device, showing a suction cup means for attaching the device for an automobile.

FIG. 6B is a perspective view of the portion of the device as shown in FIG. 6A, assembled.

FIG. 7A is an exploded front elevational view with internal features shown of an embodiment of means for detachably coupling the shaft to the means for attachment.

FIG. 7B is a front elevational view, with internal features shown, of the detachable coupling means of FIG. 7A, shown as assembled.

FIG. 8 is a front elevational view of another embodiment of a device for attaching a decorative element to an automobile in accordance with the present invention including a portion of a beach ball shown in broken lines attached to the device.

FIG. 9 is a side view of the device of FIG. 8.

FIG. 10 is a side view of the display device mount of the device of FIG. 8 including a balloon shown in broken lines attached thereto.

FIG. 11 is a top side view of the display device mount of FIG. 10 shown without the balloon.

### DETAILED DESCRIPTION OF THE INVENTION

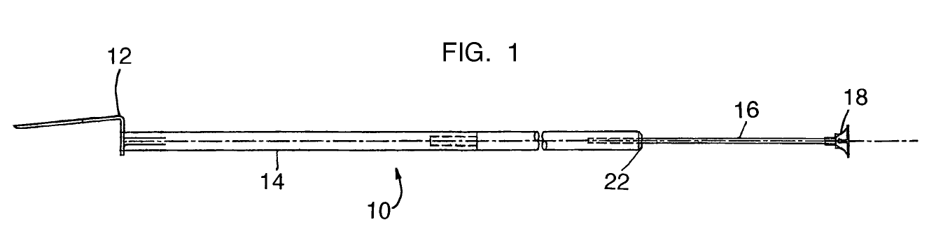

Referring initially to FIG. 1, an embodiment of the invention provides a device 10 having a means for attaching the device 10 to an automobile which can be formed as a wedge or bracket, depicted here in the form of a wide L-shaped bracket 12 adapted to slide between the outer surface of a side window of an automobile and the portion of the automobile body abutting the outer surface of the side window, namely the rain gutter. The side window and the rain gutter of the automobile body press against the wedge or bracket 12 in order to securely but removably attach the device 10 to the automobile. This feature allows installation of the device 10 on the automobile without the need to roll down the window. This provides the significant practical advantage of allowing installation or removal of the device 10 from an automobile without need for rolling the window up or down. As may be appreciated in connection with automobile sales lots with many automobiles on display, it is beneficial to avoid the laborious process of obtaining the key for each automobile, entering each automobile to roll the window down and up to install a balloon display device, and, perhaps, engaging the electrical system or starting the engine of the automobile if necessary to roll down and up an electrically-activated automatic window.

It is contemplated that the means for attaching the device 10 to an automobile, such as the bracket 12 is formed of any acceptable material such as rubber, thermoplastic material or metallic material. It is additionally contemplated that any conventional means of attaching a decorative device to an automobile also could be employed in place of the wedge or bracket 12. For example, such conventional means of attaching the decorative device could comprise a non-lever suction or vacuum cup, a lever suction cup, magnetic attachment means, or adhesive attachment means. It is contemplated that the means for attaching the device 10 to the automobile is adapted to do so without damage to the automobile exterior and to be easily and quickly removable, but is sufficiently securely attached to the automobile to provide secure attachment under windy conditions.

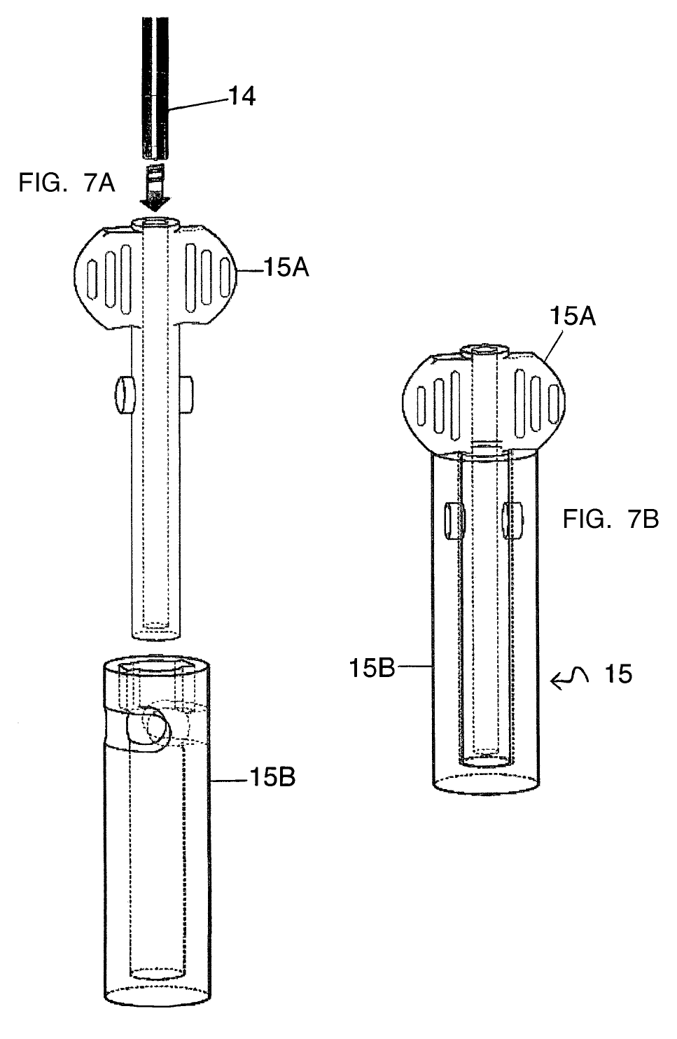

The first portion 14 of the shaft, herein depicted as a rigid shaft 14, is attached to the bracket 12 by any conventional means. For example, such means of attaching is the first portion 14 of the shaft to the bracket 12 could comprise a twist-lock joint allowing removable attachment of the first portion 14 to the bracket 12. (See FIGS. 7A, 7B and 7C). The first portion 14 extends upwardly from bracket 12 toward the rooftop of the automobile. It is also contemplated that the first portion 14 could extend at or be adjusted to any angle, forwardly or backwardly, oblique to the horizontal axis of the automobile. This would allow the device 10 optionally to display the balloon at an angle, rather than vertically, thus appearing to trail behind the automobile.

The first portion 14 is more rigid than the second portion 16, which is in the nature of a whip shaft. The first portion 14 is attached to the bracket 12, and runs directly from the top of the bracket 12, straight up or at an oblique angle as described earlier, until it reaches a point high enough to hold the shaft away from the surface of the automobile, optionally extending upward vertically past the top of the rooftop of the automobile. The first portion 14 has rigidity, by reason of material or design, sufficient to keep the lower portion of the shaft of the device 10 from moving significantly, thereby protecting the automobile from damage due to contact with the device 10 as the shaft sways in response to wind or other impetus.

The shaft's second portion 16 is attached by any conventional means 22 to the first portion 14, and is in the nature of a whip shaft. The first portion 14 and second portion 16 are connected by any conventional means or can be integrally formed. This second portion 16 is a more flexible portion, allowing relatively free movement of the balloon or other visual display item 24 to be attached at the end of the whip shaft 16. The whip shaft 16 is more flexible shaft, made so via materials or design, able to move and whip in wind in a manner resembling the natural movement of helium-filled balloons in windy conditions or when attached to moving automobiles. The whip shaft 16 extends above the rooftop of the automobile, or perhaps slightly above or beyond the rear surfaces of the automobile in the case of the oblique angle placement described above. The whipping motion of the end of the whip shaft 16 is free in any direction, but whip shaft 16 has sufficient rigidity to support the balloon above the automobile even when the balloon is filled with ordinary air rather than helium.

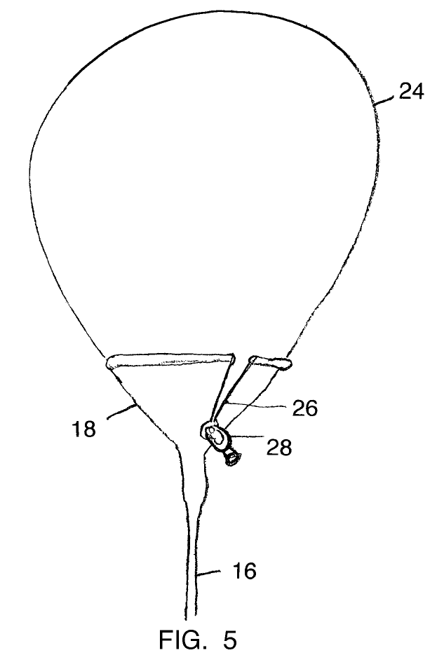

The means for attaching the balloon to the shaft 16 is depicted as a balloon cup 18 in FIG. 1, shown in more detail in FIG. 5. Alternatively, other types of conventional means of attaching a balloon to a shaft can be used. The balloon 24 can be attached by being glued, taped, tied, or otherwise adhered to the whip shaft 16.

The balloon 24 to be attached to the shaft 16 can be of any acceptable material, such as latex, plastic, or Mylar. It is contemplated that a balloon attached to the device 10 could bear any visual message desired, including decorative or useful messages. For use in connection with the invention, the balloon can be filled with ordinary air, because the device 10 has a shaft of sufficient rigidity to hold the balloon aloft in a relatively upright position even when the balloon is filled with ordinary air, thereby mimicking the appearance of a helium-filled balloon without the costs and labor associated with installing and maintaining helium-filled balloons. Alternatively, other types of display devices can be mounted to the device 10 and thereby attached to a vehicle.

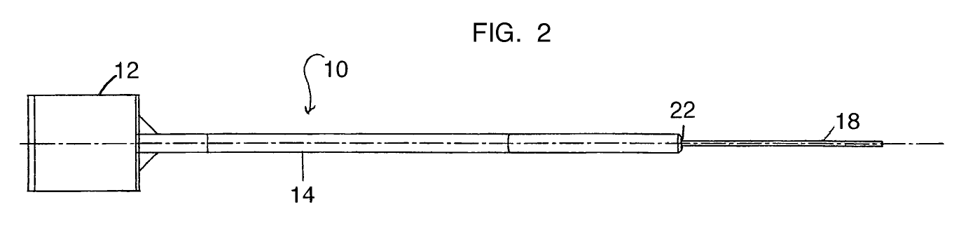

FIG. 2 depicts a portion of the device of the present invention in a front elevational view. It shows the means for attachment to an automobile window fashioned as a solid L-shaped bracket 12 that slides between the outer surface of a side window of an automobile and the rain gutter of the window. The design offers the advantage of allowing of installation or removal of the device from an automobile without the need for rolling the window up or down.

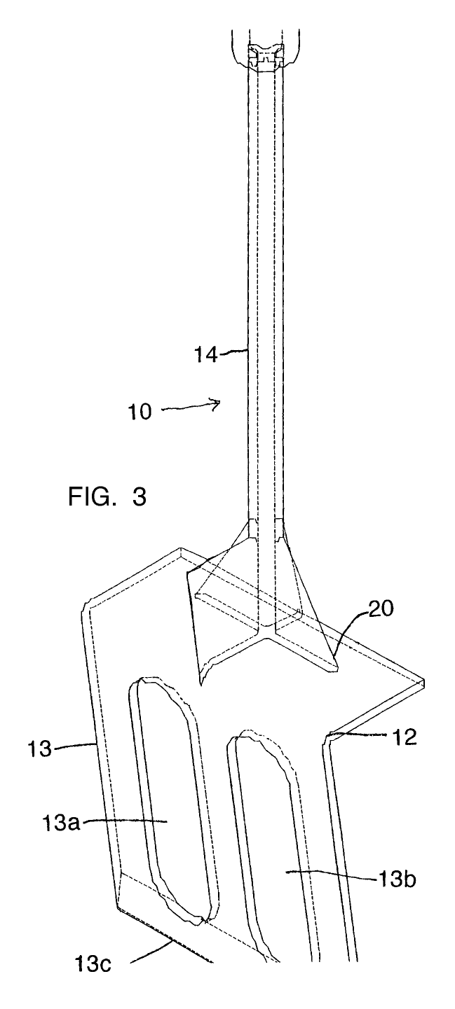

FIG. 3 depicts a portion of the device of the present invention, in a perspective view showing in more detail the bracket 12. As depicted in this view, means for attaching the balloon 24 is fashioned as an L-shaped bracket 12 that slides between the outer surface of a side window of an automobile and the rain gutter of the window, offering the advantage of allowing installation or removal of the device 10 from an automobile without the need for rolling the window up or down. FIG. 3 depicts the bracket 12 as an L-shaped member attached via attachment means 20 depicted here as a cross-shaped weld of the bracket 12 on the bracket's top arm to first shaft portion 14. Also depicted in FIG. 3 are optional apertures 13a, 13b formed in the base arm 13 of the L-shaped bracket 12 to facilitate cost-effective manufacture and facilitate flexure or easy installation or removal of bracket 13. Also depicted is the leading edge 13c of the base arm 13 of bracket 12, which is the leading edge during insertion of the base arm 13 of the bracket 12 between the window and the rain gutter when attaching the device 10 to an automobile. When installed, the bracket 12 has its top arm resting on or above the rain gutter portion of the automobile body or other structure of an automobile adjacent the window.

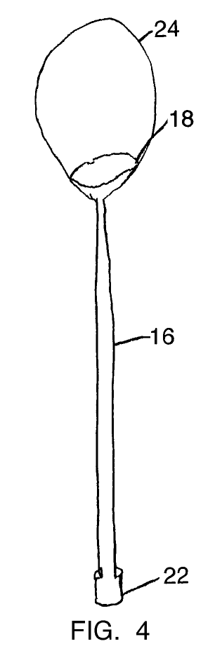

FIG. 4 depicts a portion of the device 10 in a perspective view, showing whip shaft 16 and its attachment means 22, whereby whip shaft 16 is attached by any conventional means to the first shaft portion 14. Whip shaft 16 can be formed integrally with first portion 14 of the shaft. FIG. 4 also depicts a balloon 24 attached to the balloon cup 18. It is an object of the invention to have the balloon cup 18 or other device adapted to accept balloons constructed of any acceptable material, such as latex, Mylar or plastic.

FIG. 5 is a perspective view of a portion of the device 10, showing in more detail the balloon cup 18 and the balloon 24 attached to the end of the whip shaft 16. In other embodiments, other types of attachment means are utilized to attach a balloon 24 or other type of decorative element or display device to the whip shaft 16. In the FIG. 5 embodiment, the balloon 24 is attached to a balloon cup 18, herein designed as a deformable thermoplastic balloon cup, by means of an opening or slot 26 defined by a conical sidewall 27 of the balloon cup. The knotted end 28 of a balloon is slid into and held between the opposing angled edges 29 of a lower end of the slot 26 by friction wherein the balloon 24 near the knot 28 is pinched between the opposing angled edges 29 of the deformable balloon cup 18 abutting the slot 26.

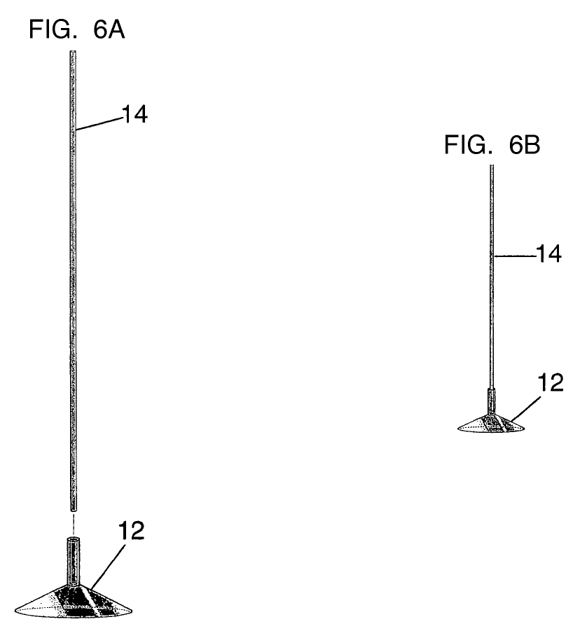

FIG. 6A is an exploded perspective view of an embodiment of a portion of the device 10, showing a means for attaching the device 10 to an automobile as a suction cup or vacuum cup 19. First shaft portion 14 is inserted or otherwise attached to the suction cup and may be coupled in either a permanent or a detachable manner. FIG. 6B shows the portion of the device 10 shown in FIG. 6A as assembled.

FIG. 7A is a partial exploded elevational view of the device 10, with internal features shown, of one embodiment of a means for detachably coupling the first shaft portion 14 to a portion 15B of a means for attaching the attaching the device to an automobile such as the bracket 12 (not shown in FIG. 7A). The advantage if detachable coupling, as can be accomplished with the feature shown in FIG. 7A, is allowing easy replacement of the balloon 24 or other type of visual display item or decorative element. The construction in FIG. 7A shows the shaft 14 being glued or otherwise permanently affixed within a receptacle formed inside the turn-key portion 15A of the means of attaching 15. Turn-key socket portion 15B then receives insertion of turn-key portion 15A, which is detachably coupled to socket portion 15B when turn-key portion 15A is rotated relative to socket portion 15B to engage protrusions on turn-key portion 15A with apertures formed on socket portion 15B, as is shown in FIG. 7B. Reversing this rotation and then removing the turn-key portion 15A from the socket portion 15B detaches portions 15A and 15B.

Instead of a receiving a balloon 24, the balloon cup 18 or other means for attachment can be shaped or otherwise adapted to attach visual devices or decorative elements other than a balloon 24 to the end of whip shaft 16, in the nature of any lightweight visual display means such as flags, pennants, banners, small placards, spinners, pinwheels, lights, or the like. A plurality of display means can be affixed to the shaft member in a number of positions along the shaft, or all at the end of the whip shaft 16.

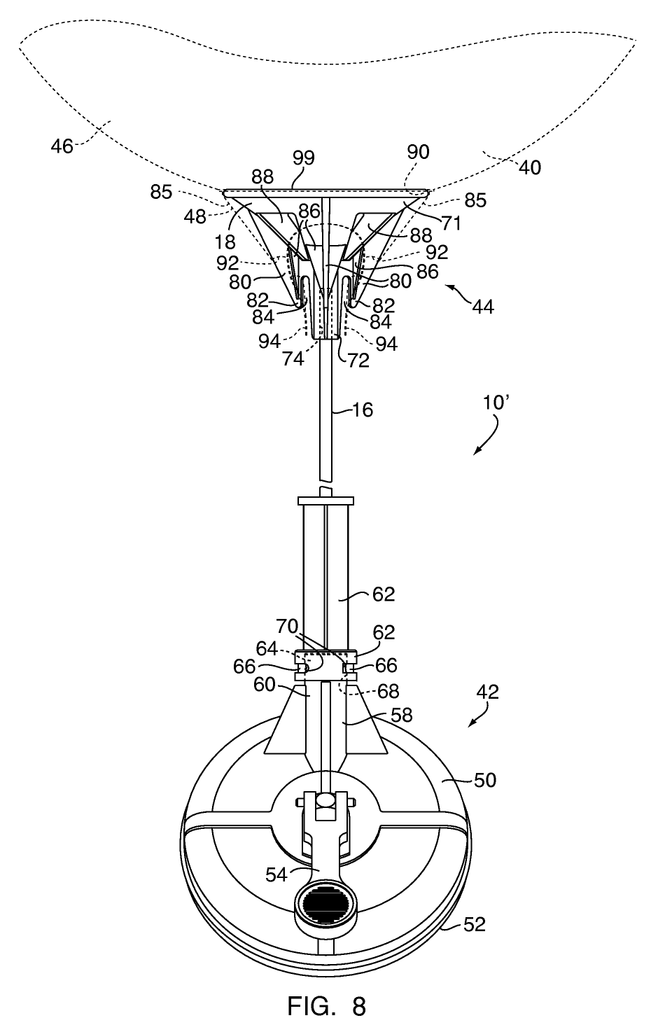

Referring to FIG. 8, another embodiment of the present invention device 10 for attaching a display device 40 to a vehicle (not shown) includes a suction cup mount 42, a shaft 16, and a display device mount 44. Although only partially shown in broken lines, in the FIG. 8 embodiment, the display device 40 is a beach ball 46 having a pocket 48 for receiving a portion of the display device mount 44.

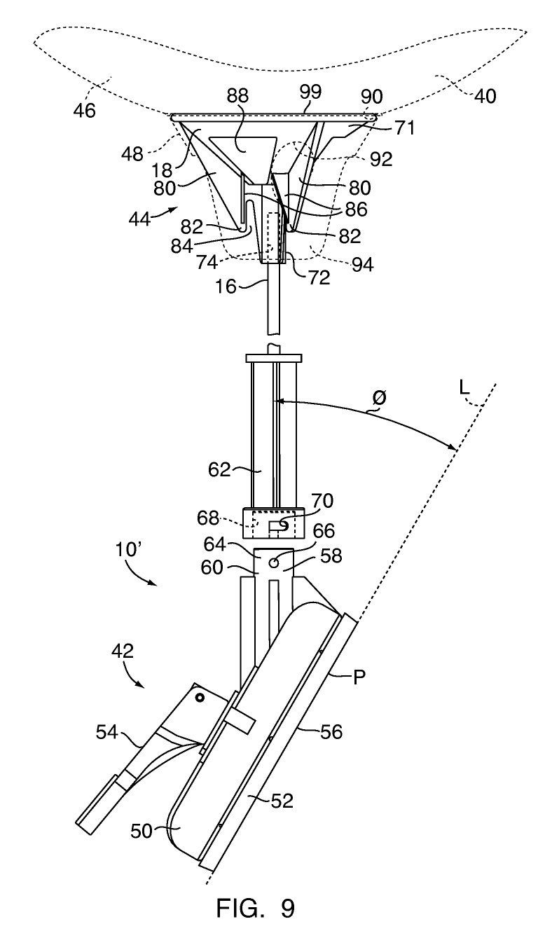

The suction cup mount 42 includes a lever-operated suction cup mount having a body 50, a seal 52 and a lever 54 for operating the seal. The seal 52 is coupled to the body 50 and the lever 54 in a known configuration. The lever 54 is movable between a lock position wherein the seal 52 is positioned for attachment to a surface, and a release position wherein the seal is in a relaxed position and the body 50 is removable from an attachment surface. The lever 54 is manually operable for moving the seal 52 between the lock and the release positions. In FIGS. 8 and 9, the lever 54 is shown in the lock position.

The seal 52 includes an attachment surface 56 which generally defines a plane P when the seal is in the release position. The attachment surface being removably attachable to a planar load surface such as a window or body panel of a vehicle via operation of the lever 52.

The body 50 further defining a shaft support 58 extending outwardly from the body 50 on a side opposite the seal 52. The shaft support 58 defines a first coupler member 60 corresponding to a mating second coupler member 62 attached to a lower end of the shaft 16. The first and second coupler members 60, 62 being removably attachable one to the other for mounting the shaft and an attached display device 40 to the suction cup mount 42 and thereby a vehicle.

Referring to FIG. 9, the device 10 includes the first and second coupler members 60, 62 defining interconnecting male and female portions respectively, that are rotatable relative to one another to lock the coupler members together. The first coupler member 60 includes a male end 64 having pins 66 extending outwardly therefrom. The male end 64 is receivable in an opening 68 defined by the corresponding second coupler member 62. The second coupler member 62 further defines slots 70 for receiving the pins 66. The pins 66 being engageable with the slots 70 for interlocking the first and second coupler members 60, 62 one to the other.

Referring to FIG. 9, the device 10 includes the shaft support 58 disposed at an angle, theta relative to the plane P defined by the attachment surface of the seal 52. Thus, the shaft support 58 is angularly disposed for positioning the shaft 16 generally vertical relative to an automobile or other vehicle having an angularly disposed load surface L such as a side window or other body panel. Preferably, the shaft support 58 is oriented at an angle theta, in a range between about 0 degrees and about 90 degrees relative to the plane P defined by the attachment surface 56 of the seal 52. In a more preferred embodiment, the angle theta between the shaft support 58 and the attachment surface 56 is in a range of about between 25 degrees and about 35 degrees. In the FIG. 9, embodiment, the angle theta is approximately 30 degrees. Thus, the device 10 can be attached to a load surface L such as the side window of an automobile via the suction cup mount 42 so that the shaft 16 is oriented approximately vertically upright for displaying a display device 40 such as the beach ball 46 above the automobile. The angle theta compensating for the angular disposition of the window so that the shaft 16 is positioned approximately vertically upright. In other embodiments, the shaft support 58 and/or body 50 is angularly adjustable relative to the attachment surface 56 so as to position the shaft 16 in a vertical position regardless of the arrangement of the load surface L. In still another embodiment, the shaft support 58 is arranged at an angle theta of about 90 degrees relative to a load surface L for use on a hood or roof of a vehicle or in other applications.

Still referring to FIGS. 8 and 9, the shaft 16 extends between the suction cup mount 42 and a display device mount 44 for supporting a display device such as the beach ball 46 above a vehicle for drawing attention to the vehicle. Typically the shaft is approximately between about 3 to about 4 feet long for supporting a display device 40 above a vehicle. However, in other embodiments of the device 10, the shaft 16 can be longer or shorter, depending on the application in which the device is used including the weather conditions as well as the flexibility of the shaft 16.

Referring to FIGS. 8-11, the display device mount 44 is attached to a second end of the shaft 16 opposite the first end and away from the suction cup mount 42 and the vehicle (not shown). The display device mount 44 includes a cone-shaped cup 18 defined by a conical sidewall 71 extending outwardly from a flange 72. The flange 72 defining a bore 74 for receiving the second end of the shaft 16. The cup 18 being coupled to the flange 72 opposite the bore 74 wherein an opening 76 defined by the cup 18 faces away from the shaft 16 for supporting a display device 40 atop of the shaft.

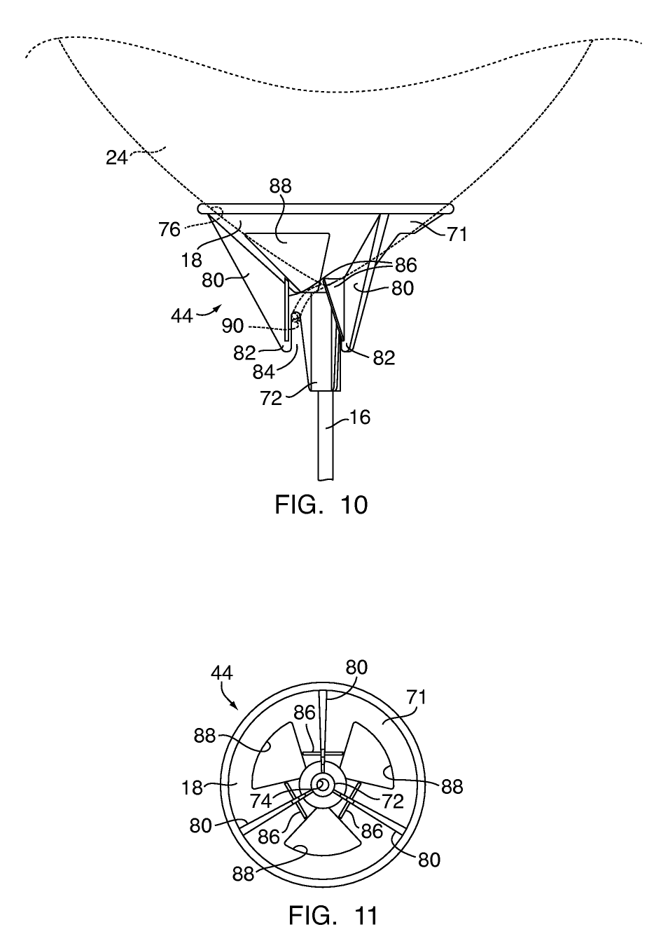

A plurality of webs 80 extend between the conical sidewall 71 of the cup 18 and the flange 72 for supporting the cup 18. In the illustrated embodiment, the display device mount 44 includes three webs 80 supporting the cup 18. In other embodiments two or four, or another number of webs 80 may be used to support the cup 18. A hook 82 formed in part by a slotted opening 84 defined by the web 80 can be used to secure a display device 40 to the display device mount 44. One or more gussets 86 are attached between the conical sidewall 71 of the cup 18 and the web 80 for supporting the web and strengthening the sidewall. An opening 88 defined by the conical sidewall 71 allows a knotted end or other portion of a balloon 24 or other display device to pass through the sidewall 71 for attachment to the web 80 via the hook 82. Referring to FIG. 10, a knotted end 90 of a balloon 24 is passed through an opening 88 defined by the sidewall and secured to the display device mount 44 at the web 80 and hook 82 thereof.

In the illustrated embodiment, the display device mount 44 includes a cup 18 having a conical sidewall 70 defining three openings 88 therethrough and having three webs 80 supporting the cup 18 from an underside of the sidewall 71. In other embodiments, the conical sidewall 71 may include two or four openings 88. Typically, the number of openings 88 corresponds to the number of webs 80 supporting the conical sidewall 71, however this is not required as there could be more or less openings 88 than the number of webs 80.

Typically, the display device mount 44 is manufactured from plastic and attached to the second end of the shaft 16 via an adhesive. The shaft 16 having the second end thereof inserted into the bore 74 defined by the flange 72 and coupled thereto with using an adhesive between the mating shaft and bore.

As shown in FIG. 8, the beach ball 46 defines a pocket 48 at a lower end thereof for attaching the beach ball to a mounting member. The pocket 48 is formed in part by opposing pocket sidewalls 85 extending outwardly from an outer surface 90 of the beach ball 48. The pocket sidewalls 85 each defining an opening 92 forming a handle 94 at the terminal end thereof. As further shown in FIG. 8, the display device mount 44 is partially inserted into the pocket 48 such that an upper edge 99 of the cup 18 is adjacent the outer surface 90 of the beach ball 48 and enclosed within the pocket 48. The hooks 82 of opposing webs 80 of the display device mount 44 extend through the pocket openings 92 of the sidewalls 85, the handles 94 being engageable with the hooks 82 for securing the beach ball 48 to the display device mount. Preferably, the diameter of the upper edge 99 of the cup 18 corresponds to the size of the pocket 48 so that the beach ball 48 is securely engageable with the display device mount 44 as set forth above.

One advantage of the display device mount 44 over prior art devices is that the webs 80 and the hooks 82 disposed below the conical sidewall of the cup 18 provide a means to attach a variety of display devices 40 to the display device mount 44. The upper edge 99 of the cup 18 provides a suitable base for supporting a various display devices above the cup and the hooks 82 disposed below the sidewall provide a convenient and available structure to secure a variety of different types of display devices to the display device mount 44. The cup 18 allows a traditional type balloon 24 or a mylar balloon to extend into the opening 76 of the cup such that an end of the balloon is secured to the display device mount 44 through the openings 88 in the sidewalls of the cup. Alternatively, other types of display devices are positionable atop the upper edge 99 of the cup 18 and secured thereto via the hooks 82 disposed below the sidewalls 70 of the cup.

In use of the device 10, typically, the beach ball 46 or other display device is first attached to the display device mount 44 prior to the shaft 16 being attached to the suction cup mount 42. The suction cup mount 42 can be attached to a window or body panel of a vehicle prior to attaching the shaft 16 to the shaft support 58. Thereafter, the shaft 16 and display device 40 is attached to the suction cup mount 42 via the coupler members 60, 62. Alternatively, the shaft 16 and display device 40 can be coupled to the suction cup mount 42 prior to the assembly being attached to a vehicle. Accordingly, any order of assembly of the component parts of the present invention can be utilized for mounting a display device 40 to a vehicle using the device 10.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A device for attaching a decorative element to a vehicle, comprising:
a support member removably attachable to a load surface of said automobile, said support member having a shaft support;
a shaft having first and second opposing ends, said first end of said shaft being removably attached to said shaft support, said shaft support being arranged for supporting said shaft in a generally upright position relative to an angularly disposed load surface;
a display device mount attached to said second end of said shaft, said display device mount including a flange defining a bore receiving said second end of said shaft and a cup defining a conical sidewall extending outwardly from said flange opposite said bore, at least one web extending between an outer surface of said conical sidewall and said flange for supporting said cup, said web defining a hook for attaching a display device thereto.

2. The device for attaching a decorative element to an automobile according to claim 1 wherein said support member includes a suction cup mount having a seal removably attachable to said load surface.

3. The device for attaching a decorative element to an automobile according to claim 2 wherein said suction cup mount further comprises an attachment surface attachable to said load surface, said attachment surface being disposed at an angle in a range of about 0 degrees to about 90 degrees relative to said shaft support.

4. The device for attaching a decorative element to an automobile according to claim 3 wherein said angle is in a range of about 25 degrees to about 35 degrees.

5. The device for attaching a decorative element to an automobile according to claim 1 wherein said shaft support includes a first coupler member and said first end of said shaft includes a second coupler member corresponding to said first coupler member, said first and second coupler members removably attachable one to the other for attaching said shaft to said shaft support.

6. A device for attaching a decorative element to a vehicle, comprising:
a suction cup mount having a body and a seal coupled to said body, said body defining a shaft support for supporting an end of a shaft, said seal defining an attachment surface releasably attachable to a load surface of said vehicle; a shaft having first and second opposing ends, said first end of said shaft attachable to said shaft support for supporting said shaft;
said shaft support being arranged so that said shaft when coupled to said shaft support is disposed at an angle relative to a plane generally defined by said attachment surface for supporting said shaft in a substantially upright position relative to an angularly disposed load surface; and
a display device mount coupled to said second end of said shaft.

7. The device for attaching a decorative element to an automobile according to claim 6 wherein said angle between said shaft and said plane is an acute angle.

8. The device for attaching a decorative element to an automobile according to claim 6 wherein said angle is in a range of about 0 degrees to about 90 degrees.

9. The device for attaching a decorative element to an automobile according to claim 6 wherein said angle in a range of about 25 degrees to about 35 degrees.

10. The device for attaching a decorative element to an automobile according to claim 6 wherein the display device mount attached to said second end of said shaft includes a flange defining a bore receiving said second end of said shaft and a cup defining a conical sidewall extending outwardly from said flange opposite said bore, at least one web extending between an outer surface of said conical sidewall and said flange for supporting said cup.

11. A display device mount for use in attaching a display device to a vehicle, said display device mount comprising:
a flange defining a bore for receiving a shaft;
a cup defining a conical sidewall extending outwardly from said flange opposite said bore; and
at least one web extending between an outer surface of said conical sidewall and said flange for supporting said cup.

12. The display device mount for use in attaching a display device to a vehicle according to claim 11 wherein the conical sidewall defines at least one opening therethrough.

13. The display device mount for use in attaching a display device to a vehicle according to claim 11 wherein the web defines a hook for attaching a display device to said display device mount.

14. The display device mount for use in attaching a display device to a vehicle according to claim 11 wherein said cup further comprises an upper edge corresponding to the size of a pocket defined by a display device such that said upper edge is receivable within said pocket for securing said display device to said display device mount.
